(19) United States
(12) Patent Application Publication
(10) Pub. No.: US 2026/0154252 A1
(43) Pub. Date: Jun. 4, 2026

(54) AI MEMORY PROCESSING METHOD AND APPARATUS, DEVICE, AND AI MEMORY PROCESSING SYSTEM

(71) Applicant: OpenInterX INC., Wilmington, DE (US)

(72) Inventor: Junxiao SHEN, Wilmington, DE (US)

(21) Appl. No.: 18/967,165

(22) Filed: Dec. 3, 2024

(51) Int. Cl. G06F 16/23; G06F 16/2455

(52) U.S. Cl. CPC G06F 16/2365; G06F 16/2455

(57) ABSTRACT

An artificial intelligence (AI) memory processing method includes acquiring multimodal data; and converting the multimodal data into parametric memory data and non-parametric memory data, where the non-parametric memory data includes memory data stored in a memory unit, and the parametric memory data includes memory data stored in a parameter of an AI model. An AI memory processing device includes at least one processor and a memory unit communicatively connected to the at least one processor; where the memory unit stores a computer program executable by the at least one processor to enable the at least one processor to perform the preceding method.

### TECHNICAL FIELD

Embodiments of the present application relate to the technical field of artificial intelligence (AI) and, in particular, to an AI memory processing method and apparatus, a device, and an AI memory processing system.

### BACKGROUND

In recent years, AI technology has developed rapidly, and some AI wearable devices can provide users with convenient and personalized functions. With increasingly rich AI functions, these devices need to collect and process a larger volume of more diverse information. However, due to relatively high requirements on weight, volume, and portability, a memory of an AI wearable device has a greatly limited capacity and is not enough to store all data required for various AI functions. Moreover, it is not intelligent enough to simply store and read data. How to intelligently store and memorize diverse data has become a great challenge.

### SUMMARY

The present application provides an AI memory processing method and apparatus, a device, and an AI memory processing system to implement the intelligent storage and memory of multimodal data.

Some embodiments of the present application provide an AI memory processing method. The method is applied to an AI memory processing device and includes the steps below.

Multimodal data is acquired.

The multimodal data is converted into parametric memory data and non-parametric memory data, where the non-parametric memory data includes memory data stored in a memory unit, and the parametric memory data includes memory data stored in a parameter of an AI model.

Some embodiments of the present application provide an AI memory processing method. The method is applied to a data collection device and includes the steps below.

Multimodal data is collected.

The multimodal data is transmitted to a memory processing device enable the memory processing device to convert the multimodal data into parametric memory data and non-parametric memory data, where the non-parametric memory data includes memory data stored in a memory, and the parametric memory data includes memory data stored in a parameter of an AI model.

Some embodiments of the present application provide an AI memory processing apparatus. The apparatus includes a data acquisition module and a memory conversion module.

The data acquisition module is configured to acquire multimodal data.

The memory conversion module is configured to convert the multimodal data into parametric memory data and non-parametric memory data, where the non-parametric memory data includes memory data stored in a memory unit, and the parametric memory data includes the memory data stored in a parameter of an AI model.

Some embodiments of the present application provide an AI memory processing apparatus. The apparatus includes a data collection module and a data transmission module.

The data collection module is configured to collect multimodal data.

The data transmission module is configured to transmit the multimodal data to a memory processing device to enable the memory processing device to convert the multimodal data into parametric memory data and non-parametric memory data, where the non-parametric memory data includes memory data stored in a memory unit, and the parametric memory data includes memory data stored in a parameter of an AI model.

Some embodiments of the present application provide a memory processing device. The memory processing device includes at least one processor and a memory unit.

The memory unit is configured to store at least one program.

The at least one program, when executed by the at least one processor, causes the at least one processor to perform the preceding method.

Some embodiments of the present application provide a data collection device. The data collection device includes at least one processor and a memory unit.

The memory unit is configured to store at least one program.

The at least one program, when executed by the at least one processor, causes the at least one processor to perform the preceding AI memory processing method.

Some embodiments of the present application provide an AI memory processing system including the preceding memory processing device and the preceding data collection device.

Embodiments of the present application provide the AI memory processing method and apparatus, the device, and the AI memory processing system. The method includes acquiring the multimodal data; and converting the multimodal data into the parametric memory data and the non-parametric memory data, where the non-parametric memory data includes the memory data stored in the memory, and the parametric memory data includes memory data stored in the parameter of an AI model. According to the preceding technical solutions, the multimodal data is converted into the parametric memory data and the non-parametric memory data, the non-parametric memory data is stored in the memory unit, and the parametric memory data is stored in the parameter of the AI model so that the AI model has a memory ability, the intelligent storage and memory of the multimodal data are implemented, and AI memory is used to provide users with more personalized and comprehensive responses and services.

### BRIEF DESCRIPTION OF DRAWINGS

The above and other features, advantages, and aspects of embodiments of the present disclosure become more apparent with reference to the embodiments described below in conjunction with the drawings. The same or similar reference numerals throughout the drawings denote the same or similar elements. It is to be understood that the drawings are schematic and that originals and elements are not necessarily drawn to scale.

FIG. 1 is a flowchart of an AI memory processing method according to some embodiments of the present application.

FIG. 2 is a schematic diagram of conversion of multimodal data into AI memory according to some embodiments.

FIG. 3 is a schematic diagram of a process of forming and using non-parametric memory data according to some embodiments.

FIG. 4 is a flowchart of an AI memory processing method according to some embodiments of the present application.

FIG. 5 is a structural diagram of an AI memory processing apparatus according to some embodiments of the present application.

FIG. 6 is a structural diagram of an AI memory processing apparatus according to some embodiments of the present application.

FIG. 7 is a memory processing device according to some embodiments of the present application.

FIG. 8 is a structural diagram of a data collection device according to some embodiments of the present application.

FIG. 9 is a structural diagram of a memory processing system according to some embodiments of the present application.

FIG. 10 is a structural diagram of a memory processing system according to some embodiments of the present application.

FIG. 11 is a schematic diagram of data interaction between a data collection device, a memory processing device, and an inference device according to some embodiments of the present application.

### DETAILED DESCRIPTION

The present application is further described in detail hereinafter in conjunction with the drawings and embodiments. It is to be understood that the embodiments described herein are intended to illustrate the present application and not to limit the present application. Additionally, it is to be noted that for ease of description, only part, not all, of structures related to the present application are illustrated in the drawings.

Before example embodiments are discussed in more detail, it is to be noted that some example embodiments are described as processing or methods depicted in flowcharts. Although steps are described as sequential processing in a flowchart, many of the steps may be performed concurrently, coincidently, or simultaneously. Additionally, the sequence of the steps may be rearranged. The processing may be terminated when operations thereof are completed, but the processing may further have additional steps that are not included in the drawings. The processing may correspond to a method, a function, a procedure, a subroutine, a subprogram, or the like.

It is to be noted that concepts such as “first” and “second” mentioned in embodiments of the present application are used only to distinguish between different apparatuses, modules, units, or other objects and are not intended to limit the order of or interdependence between functions performed by these apparatuses, modules, units, or other objects.

Additionally, if not in conflict, embodiments of the present application and features therein may be combined with each other.

In technical solutions of the present application, the acquisition, storage, use, and processing of data all comply with relevant provisions of national laws and regulations.

It is to be noted that in the embodiments of the present application, existing solutions such as software, components, and models in the industry are possible to be mentioned, and the existing solutions are to be considered as illustrative and are intended to illustrate the feasibility of implementing the technical solutions of the present application and not to mean that the applicant has used or will certainly use the relevant content of the solutions.

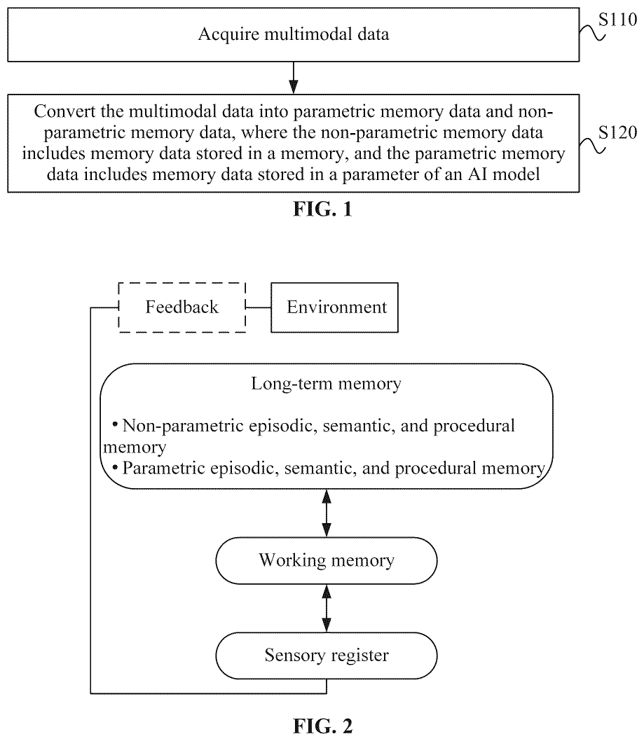

FIG. 1 is a flowchart of an AI memory processing method according to an embodiment of the present application. This embodiment is applicable to the generation of AI memory by use of multimodal data. Specifically, the AI memory processing method may be performed by an AI memory processing apparatus. The AI memory processing apparatus may be implemented by software and/or hardware and integrated into a memory processing device. The memory processing device includes, but is not limited to, a device with a data processing function, such as a computer, a smartphone, or a server. The memory processing device (which may also be referred to as a memory center, hub, or data processing device) may be configured to process the multimodal data, form and store the AI memory, and provide personalized help for users according to the AI memory.

As shown in FIG. 1, the method includes the steps below.

In S110, the multimodal data is acquired.

In this embodiment, the multimodal data may refer to a data set consisting of at least two different types of data, which are generally required for AI functions. The data may be in multiple forms such as inertial measurement unit (IMU) data, depth information, texts, images, audio, and/or videos, and each form may be understood as one modality. The core of the multimodal data is that more comprehensive multi-dimensional information can be provided through different types of data, thereby improving AI performance.

It is to be understood that the multimodal data may be collected by the memory processing device or a data collection device. As an example, the data collection data collects and transmits the multimodal data to the memory processing device, and the memory processing device processes the multimodal data after receiving the multimodal data. The data collection device may be a wearable device. A device of collecting the multimodal data may be provided with a camera, a microphone, and/or other sensors to collect data of various modalities.

In S120, the multimodal data is converted into parametric memory data and non-parametric memory data, where the non-parametric memory data includes memory data stored in a memory unit, and the parametric memory data includes the memory data stored in a parameter of the AI model.

In this embodiment, the multimodal data may be converted into two forms of memory data: the parametric memory data and the non-parametric memory data. The two forms of memory data may be used in the subsequent use of the AI functions.

The conversion of the multimodal data into the parametric memory data may be understood as that the multimodal data is associated with the parameter of the AI model and implicitly stored in the parameter of the AI model. The parameter mainly refers to a parameter in the AI model and may include a weight and a hyperparameter in a neural network, a K value or a training set in a K-nearest neighbors model, and a weight and a kernel function in a support vector machine. Alternatively, the conversion of the multimodal data into the parametric memory data may be understood as that the parameter of the AI model is trained or adjusted using the multimodal data so that the AI model has a memory ability for the multimodal data. The parameter of the AI model may be used as memory data of the multimodal data. When inference is made for the same or similar data, the AI model may implement relatively accurate inference based on the parameter of the AI model and according to the memory data.

The conversion of the multimodal data into the non-parametric memory data may be understood as that the multimodal data is actually stored in the memory unit. For example, the multimodal data is converted into a vector and stored as memory data in an external medium such as a database (such as a relational database and/or a vector database), a file system, or a computer memory. Specifically, the multimodal data may be stored in relational data in an original form, such as text annotations or structured tags so that AI can retrieve and use such information as required to support inference. Alternatively, the multimodal data may be stored in the form of the vector, and when an AI function is used subsequently, required memory data may be queried or retrieved from the memory unit.

It is to be understood that each piece of multimodal data may be converted into parametric memory data and/or non-parametric memory data. For example, an image may be converted into the non-parametric memory data and stored in the memory unit or may be used to train the AI model and embodied in the parameter of the AI model.

According to the memory processing method of this embodiment, the multimodal data is converted into the parametric memory data and the non-parametric memory data so that long-term memory of AI can be formed to help an AI system gain a general understanding. For example, learned knowledge is integrated to enhance a question-answering system. For example, associations between current and past scenarios are established. For example, key features in frames or clips are stored for timely retrieval. In this manner, the intelligent storage and memory of the multimodal data are implemented, the AI performance is improved, and the AI memory is used to provide the users with more personalized and comprehensive responses and services.

FIG. 2 is a schematic diagram of conversion of multimodal data into AI memory according to an embodiment. As shown in FIG. 2, a framework for converting the multimodal data into the AI memory may include the following key components: a sensory register module that captures and transmits external stimuli, a working memory module that manages interaction with long-term memory while processing the stimuli, and a long-term memory module responsible for relatively permanent storage of information. The storage, retrieval, and previous processes of the long-term memory may be implemented in a feedback loop that interacts with an environment and utilizes an optimization method (such as reinforcement learning). The parametric memory data and the non-parametric memory data may be collectively referred to as the AI memory or the long-term memory. The two forms of memory data may each further include episodic memory, semantic memory, and procedural memory. Non-parametric episodic memory may be features of empirical data or video frames. Parametric episodic memory may be achieved by inputting non-parametric memory as a training set into the AI model or using a recurrent neural network that supports an update of a model parameter in an inference process. Non-parametric semantic memory may be achieved by recording knowledge in a graphical format. Parametric semantic memory may be achieved by inputting relevant information as a training set into the AI model. Non-parametric procedural memory may be achieved by a production rule. Parametric procedural memory may be achieved through the reinforcement learning.

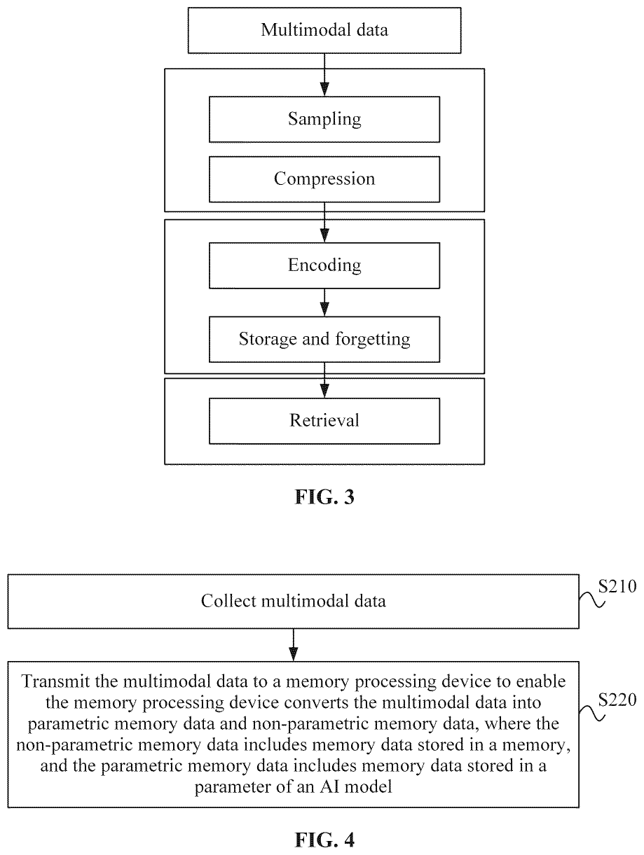

FIG. 3 is a schematic diagram of a process of forming and using non-parametric memory data according to an embodiment. As shown in FIG. 3, the process of forming and using the non-parametric memory mainly includes sampling, compression, encoding, storage and forgetting, and retrieval (use).

In an embodiment, that the multimodal data is converted into the non-parametric memory data includes S1210 and S1220.

In S1210, the multimodal data is sampled and compressed.

The sampling may refer to extracting sample data from the original multimodal data for subsequent processing. The multimodal data is sampled so that a size of the multimodal data can be reduced. A specific sampling manner is not limited in this embodiment and may be, for example, random sampling (randomly selecting the sample data), stratified sampling (dividing the original multimodal data into multiple strata, and selecting the sample data from the strata), or systematic sampling (according to a certain rule, extracting the sample data at certain intervals or distances). The multimodal data is compressed so that a data storage space can be reduced, data transmission efficiency can be improved, and data processing complexity can be reduced. A specific compression manner is not limited in this embodiment and may be lossless compression and/or lossy compression. On this basis, the multimodal data is sampled and compressed so that data processing efficiency and accuracy can be improved.

In S1220, a multimodal encoder converts the compressed multimodal data into the vector and stores the vector into the vector database.

The multimodal encoder is mainly configured to encode data of different modalities to obtain corresponding vectors. For example, the data is converted into a digital list or matrix. The vectors are stored in the vector database as the non-parametric memory data for subsequent query and retrieval.

In an embodiment, the method further includes S1230.

In S1230, redundant data is deleted from the vector database.

A process of deleting the redundant data from the vector database may be understood as a process of forgetting the non-parametric memory data. The redundant data is actively deleted so that a storage space can be optimized and the efficiency can be improved. For example, memory data may be deleted according to redundancy and/or information validity.

In an embodiment, the method further includes S1240.

In S1240, a matching vector is retrieved from the vector database according to a memory data retrieval request to obtain a memory data retrieval result.

During use of memory data, for the non-parametric memory data, the matching vector may be retrieved from vectors in the vector database according to a retrieval request and used as a retrieval result. In this process, the content in the retrieval request may be converted into a vector, and similarity retrieval may be performed on the vector database to find the matching vector. The retrieval may be sparse retrieval or dense retrieval.

In an embodiment, that the multimodal data is converted into the parametric memory data includes S1250.

In S1250, a memory model is trained using the multimodal data to update a model parameter of the memory model.

The memory model may be understood as an AI model for storing the parametric memory data. The multimodal data is learned by the memory model so that the model parameter of the memory model is updated and used as the parametric memory data.

In an embodiment, the method further includes S1260.

In S1260, based on the model parameter of the memory model, a queried content is inferred and a query result is output.

The use (or retrieval) of the parametric memory data is embodied as an inference process of the model. For example, the query and retrieval of the parametric memory data may be implemented through forward propagation of the AI model. As an example, in a convolutional neural network, deep features may be extracted in a forward propagation process, which is the retrieval of the parametric memory data.

It is to be noted that the inference process of the model may be performed in the memory processing device, in an edge computing device (such as a mobile phone or another user device), or in the cloud (such as a server).

In an embodiment, the multimodal data may be converted into the parametric memory data in a standby process of the memory processing device. On this basis, the normal operation of the memory processing device can be prevented from being affected.

In an embodiment, measures may be taken to prevent catastrophic forgetting of the parametric memory data. For example, the parameter of the AI model may be optimized using a suitable training strategy so that when new parametric memory data is formed, the updated parameter of the AI model can also represent old parametric memory data.

In an embodiment, the multimodal data includes image data and/or video data with a first resolution; and the method further includes S130. In S130, in response to a viewing operation of a user, quality enhancement is performed on the image data and/or the video data with the first resolution so that image data and/or video data with a second resolution are displayed to the user, where the second resolution is higher than the first resolution.

In this embodiment, as memory data, the acquired or collected image data and/or video data may have a relatively low resolution of, for example, 240p. The AI functions can understand the world without a high resolution. When the image data and/or video data are to be viewed through the memory processing device, the image data and/or video data may be subjected to the quality enhancement and displayed to the user at a higher resolution (such as 2K, 4K, or 1080p). On this basis, a memory can be saved, and video recording can be performed for a long time to provide enough memory information input for the AI functions, thereby improving memory efficiency and performance. Additionally, the wearable device may adopt a chip with a low power consumption and a battery with a larger capacity to further achieve a long battery life of the data collection device.

FIG. 4 is a flowchart of an AI memory processing method according to an embodiment of the present application. This embodiment is applicable to the generation of AI memory by use of multimodal data. Specifically, the AI memory processing method may be performed by an AI memory processing apparatus. The AI memory processing apparatus may be implemented by software and/or hardware and integrated into a data collection device. The data collection device includes, but is not limited to, a mobile phone, a mobile device, a portable device, or a wearable device. The data collection device may be provided with a camera, a microphone, and/or various sensors to collect data of different modalities.

As shown in FIG. 4, the method includes the steps below.

In S210, the multimodal data is collected.

In S220, the multimodal data is transmitted to a memory processing device to enable the memory processing device to convert the multimodal data into parametric memory data and non-parametric memory data, where the non-parametric memory data includes memory data stored in a memory unit, and the parametric memory data includes memory data stored in a parameter of an AI model.

In an embodiment, the multimodal data includes image data and/or video data. That the multimodal data is collected includes collecting the image data and/or the video data based on a first resolution, where the first resolution is lower than a second resolution, and the second resolution is a resolution of image data and/or video data displayed to a user by the memory processing device.

In an embodiment, the multimodal data includes IMU data, video data, and/or audio data; and the method further includes S230.

In S230, a frame rate of the multimodal data is determined based on a trained classification model.

A frame rate adjustment result of the multimodal data is output from the trained model. The multimodal data may be text data, the image data, the IMU data, the video data, the audio data, depth information, and biological information. For example, a high frame rate may be used in the case of a high movement speed, and a low frame rate may be used otherwise. For example, a high frame rate is used when content of interest is recognized in audio, and a low frame rate is used otherwise. The model may be a classification model, the input of the model is the multimodal data, and the output of the model is a frame rate gear, such as 1 frame, 5 frames, 10 frames, or 15 frames.

Based on the above, a memory can be saved, and video recording can be performed for a long time to provide enough memory information input for AI functions, thereby improving memory efficiency and performance and achieving a long battery life of the data collection device.

In an embodiment, the memory processing device and the data collection device are different devices. The data collection device may be the wearable device, the mobile device, or the portable device and can be conveniently carried by the user for use anytime and anywhere. Considering a limited memory thereof, the data collection device generally does not support recording for a long time and cannot provide the input of data such as video and audio for the AI functions for a long time. Moreover, the computing power of the data collection device generally does not support an AI memory function. The memory processing device converts the multimodal data into the parametric memory data and the non-parametric memory data so that the intelligent storage and memory of the multimodal data are implemented, the computing power of the data collection device can be saved, and the processing efficiency of the AI memory can be improved. Additionally, the data collection device lacks privacy security protection. Once the data collection device is lost, personal data is easily leaked. Especially when AI is used as an assistant, the AI functions involve a lot of user information. The AI memory is stored by the memory processing device so that this problem can be solved. Since parametric memory and non-parametric memory are only readable by a deep learning model and are not intuitively displayed to illegal users, the privacy security of the user can be fully protected.

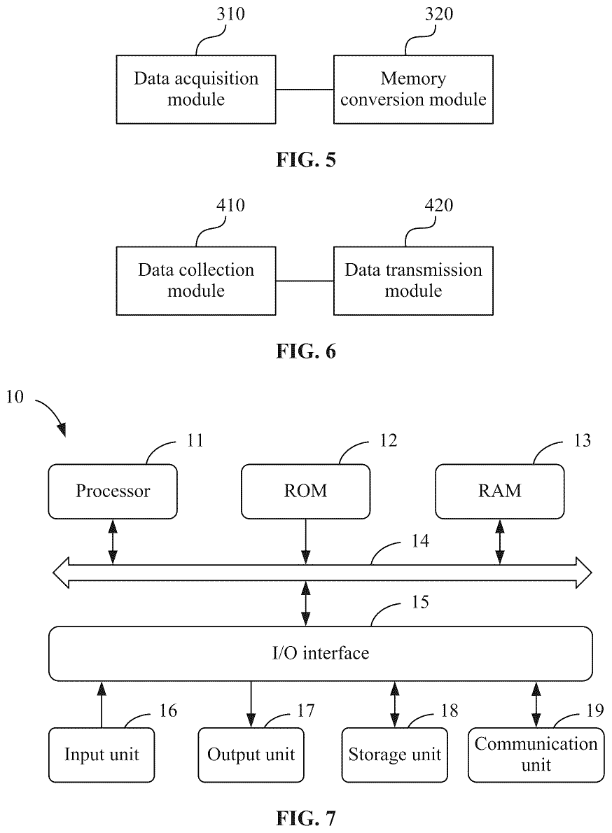

FIG. 5 is a structural diagram of an AI memory processing apparatus according to an embodiment of the present application. The AI memory processing apparatus of this embodiment includes a data acquisition module 310 and a memory conversion module 320.

The data acquisition module 310 is configured to acquire multimodal data.

The memory conversion module 320 is configured to convert the multimodal data into parametric memory data and non-parametric memory data, where the non-parametric memory data includes memory data stored in a memory unit, and the parametric memory data includes memory data stored in a parameter of an AI model.

Optionally, the memory conversion module 320 includes a non-parametric memory unit.

The non-parametric memory unit is configured to sample and compress the multimodal data and convert, through a multimodal encoder, compressed multimodal data into a vector and store the vector into a vector database.

Optionally, the apparatus further includes a forgetting module.

The forgetting module is configured to delete redundant data from the vector database.

Optionally, the apparatus further includes a non-parametric memory retrieval module.

The non-parametric memory retrieval module is configured to retrieve a matching vector from the vector database according to a memory data retrieval request to obtain a memory data retrieval result.

Optionally, the memory conversion module 320 includes a parametric memory module.

The parametric memory module is configured to train a memory model using the multimodal data to update a model parameter of the memory model.

Optionally, the apparatus further includes a parametric memory inference module.

The parametric memory inference module is configured to, based on the model parameter of the memory model, infer a queried content and output a query result.

Optionally, the memory conversion module 320 is configured to convert the multimodal data into the parametric memory data in a standby process of a memory processing device.

Optionally, the multimodal data includes image data and/or video data with a first resolution.

The apparatus further includes an enhancement module, which is configured to, in response to a viewing operation of a user, perform quality enhancement on the image data and/or the video data with the first resolution to display image data and/or video data with a second resolution to the user, where the second resolution is higher than the first resolution.

The AI memory processing apparatus according to the embodiment of the present application may perform the AI memory processing method according to any one of the preceding embodiments and has corresponding functions and beneficial effects.

FIG. 6 is a structural diagram of an AI memory processing apparatus according to an embodiment of the present application. The AI memory processing apparatus of this embodiment includes a data collection module 410 and a data transmission module 420.

The data collection module 410 is configured to collect multimodal data.

The data transmission module 420 is configured to transmit the multimodal data to a memory processing device to enable the memory processing device to convert the multimodal data into parametric memory data and non-parametric memory data, where the non-parametric memory data includes memory data stored in a memory unit, and the parametric memory data includes memory data stored in a parameter of an AI model.

Optionally, the multimodal data includes image data and/or video data.

The data collection module 410 is configured to collect the image data and/or the video data based on a first resolution, where the first resolution is lower than a second resolution, and the second resolution is a resolution of image data and/or video data displayed to a user by the memory processing device.

Optionally, the multimodal data includes IMU data, video data, and/or audio data.

The apparatus further includes a frame rate adjustment module, which is configured to determine a frame rate of the multimodal data based on a trained classification model.

FIG. 7 is a structural diagram of a memory processing device 10 that can implement an embodiment of the present application. The memory processing device 10 is intended to represent various forms of digital computers, for example, a laptop computer, a desktop computer, a worktable, a personal digital assistant, a server, a blade server, a mainframe computer, and an applicable computer. The memory processing device 10 may also represent various forms of mobile apparatuses, for example, a personal digital assistant, a cellphone, a smartphone, a user device, and a similar computing apparatus. Herein the shown components, the connections and relationships between these components, and the functions of these components are illustrative and are not intended to limit the implementation of the present application as described and/or claimed herein.

As shown in FIG. 7, the memory processing device 10 includes at least one processor 11 and a memory unit communicatively connected to the at least one processor 11, such as a read-only memory (ROM) 12 and a random-access memory (RAM) 13. The memory unit stores a computer program executable by the at least one processor. The processor 11 can perform various appropriate actions and processing according to a computer program stored in the ROM 12 or a computer program loaded into the RAM 13 from a storage unit 18. Various programs and data required for the operation of the memory processing device 10 may also be stored in the RAM 13. The processor 11, the ROM 12, and the RAM 13 are connected to each other through a bus 14. An input/output (I/O) interface 15 is also connected to the bus 14.

Multiple components in the memory processing device 10 are connected to the I/O interface 15. The multiple components include an input unit 16 such as a keyboard or a mouse, an output unit 17 such as various types of display or speaker, the storage unit 18 such as a magnetic disk or an optical disk, and a communication unit 19 such as a network card, a modem, or a wireless communication transceiver. The communication unit 19 allows the memory processing device 10 to exchange information/data with other devices over a computer network such as the Internet and/or various telecommunications networks and wireless networks.

The processor 11 may be various general-purpose and/or special-purpose processing components having processing and computing capabilities. Examples of the processor 11 include, but are not limited to, a central processing unit (CPU), a graphics processing unit (GPU), a special-purpose AI computing chip, a processor executing machine learning models and algorithms, a digital signal processor (DSP), and any appropriate processor, controller, and microcontroller. The processor 11 performs the preceding methods and processing.

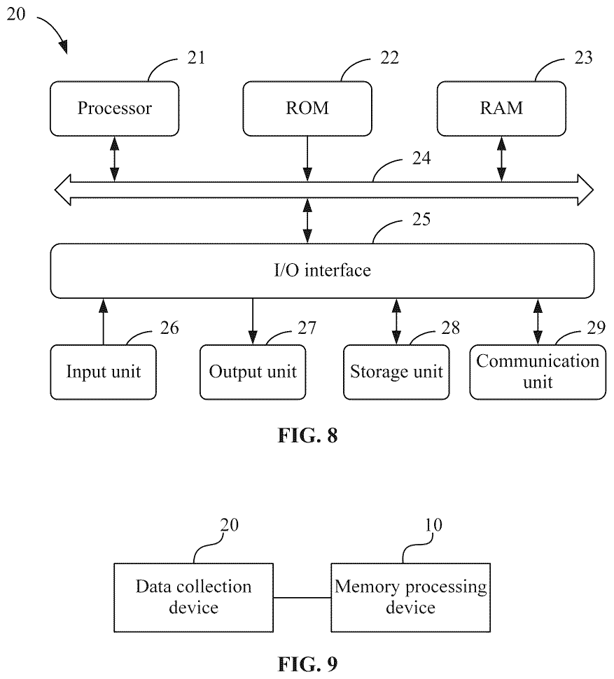

FIG. 8 is a structural diagram of a data collection device 20 that can implement an embodiment of the present application. The data collection device 20 is intended to represent various forms of digital computers, for example, a laptop computer, a desktop computer, a worktable, a personal digital assistant, a server, a blade server, a mainframe computer, and an applicable computer. The data collection device 20 may also represent various forms of mobile apparatuses, for example, a personal digital assistant, a cellphone, a smartphone, a user device, and a similar computing apparatus. Herein the shown components, the connections and relationships between these components, and the functions of these components are illustrative and are not intended to limit the implementation of the present application as described and/or claimed herein.

As shown in FIG. 8, the data collection device 20 includes at least one processor 21 and a memory unit communicatively connected to the at least one processor 21, such as a ROM 22 and a RAM 23. The memory unit stores a computer program executable by the at least one processor. The processor 21 can perform various appropriate actions and processing according to a computer program stored in the ROM 22 or a computer program loaded into the RAM 23 from a storage unit 28. Various programs and data required for the operation of the data collection device 20 may also be stored in the RAM 23. The processor 21, the ROM 22, and the RAM 23 are connected to each other through a bus 24. An I/O interface 25 is also connected to the bus 24.

Multiple components in the data collection device 20 are connected to the I/O interface 25. The multiple components include an input unit 26 such as a keyboard or a mouse, an output unit 27 such as various types of display or speaker, the storage unit 28 such as a magnetic disk or an optical disk, and a communication unit 29 such as a network card, a modem, or a wireless communication transceiver. The communication unit 29 allows the data collection device 20 to exchange information/data with other devices over a computer network such as the Internet and/or various telecommunications networks and wireless networks.

The processor 21 may be various general-purpose and/or special-purpose processing components having processing and computing capabilities. Examples of the processor 21 include, but are not limited to, a CPU, a GPU, a special-purpose AI computing chip, a processor executing machine learning models and algorithms, a DSP, and any appropriate processor, controller, and microcontroller. The processor 21 performs the preceding methods and processing.

FIG. 9 is a structural diagram of a memory processing system according to an embodiment. As shown in FIG. 9, the system includes the memory processing device 10 according to any preceding embodiment and the data collection device 20 according to any preceding embodiment.

For example, the data collection device 20 may be a wearable device that can be attached to a clothing of a user via a magnetic sheet. When withdrawn, the magnetic sheet may be fixed to the memory processing device 10. The wearable device is fixed to the memory processing device 10 via the magnetic sheet.

Optionally, the system further includes an inference device, which is configured to, based on parametric memory data, infer a queried content and output a query result.

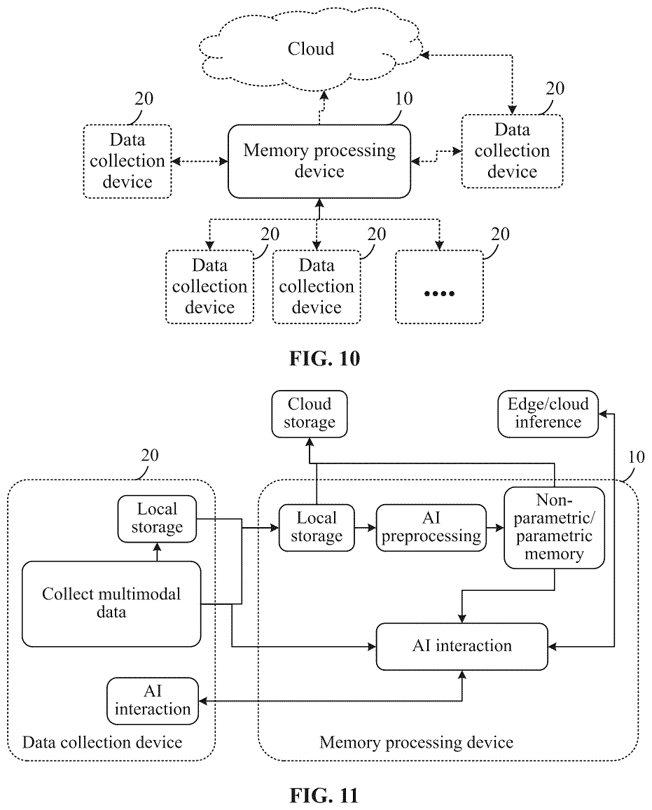

FIG. 10 is a structural diagram of a memory processing system according to an embodiment. As shown in FIG. 10, data collection devices 20 may be mobile devices or wearable devices such as headphones, smart glasses, a mobile phone, a wearable camera, a smart brooch, a smart ring, and/or any smart head-mounted device. These devices may all serve as input for AI memory, and results output from a memory processing device 10 may be presented on the headphones, the smart glasses, and/or the mobile phone so that an AI assistant has better functions and is more convenient to use. Additionally, the memory processing device 10 and a data collection device 20 may be connected to the cloud, and some complex operations (such as large model inference) are performed in the cloud.

FIG. 11 is a schematic diagram of data interaction between a data collection device, a memory processing device, and an inference device according to an embodiment. As shown in FIG. 11, the data collection device may be a camera, a hub refers to the memory processing device, and the inference device may be an edge device or a cloud device. The data collection device, the memory processing device, and the inference device may communicate with each other through wireless fidelity/Bluetooth/Universal Serial Bus (Wi-Fi/BT/USB) or in other wireless/wired transmission manners, which are not limited in this embodiment. Optionally, an image or a video collected by the camera may have a relatively low resolution, and a camera preview function may be provided at the hub end. When a user views the image or the video through the hub, the image or the video may be subjected to quality enhancement and displayed to the user at a relatively high resolution. On this basis, a data processing amount for forming AI memory can be reduced, and the user can be guaranteed to view a high-definition image or video. In this manner, both the formation efficiency of the AI memory and the user experience are considered. Additionally, the data collection device and the memory processing device can support AI interaction. For example, interaction with the user may be implemented in various manners such as voice, text, and/or display. In this case, the memory processing device endows AI with a long-term memory function so that the user can be provided with more personalized and comprehensive responses and services.

In some embodiments, the method in the preceding embodiments may be implemented as a computer program tangibly included in a computer-readable storage medium such as the storage unit. In some embodiments, part or all of computer programs may be loaded and/or installed onto the device 10 or the data collection device 20 via the ROM and/or the communication unit. When the computer programs are loaded into the RAM and executed by the processor, one or more steps of the preceding method may be performed. Alternatively, in other embodiments, the processor may be configured in any other appropriate manner (for example, by means of firmware) to perform the method according to any preceding embodiment.

Herein various embodiments of the preceding systems and techniques may be implemented in digital electronic circuitry, integrated circuitry, field-programmable gate arrays (FPGAs), application-specific integrated circuits (ASICs), application-specific standard products (ASSPs), systems on chips (SoCs), complex programmable logic devices (CPLDs), computer hardware, firmware, software, and/or combinations thereof. The various embodiments may include implementations in one or more computer programs. The one or more computer programs are executable and/or interpretable on a programmable system including at least one programmable processor. The programmable processor may be a special-purpose or general-purpose programmable processor for receiving data and instructions from a memory system, at least one input apparatus, and at least one output apparatus and transmitting data and instructions to the memory system, the at least one input apparatus, and the at least one output apparatus.

Computer programs for implementation of the methods of the present application may be written in one programming language or any combination of multiple programming languages. The computer programs may be provided for a processor of a general-purpose computer, a special-purpose computer, or another programmable data processing apparatus to enable functions/operations specified in a flowchart and/or a block diagram to be implemented when the computer programs are executed by the processor. The computer programs may be executed entirely on a machine, partly on a machine, as a stand-alone software package, partly on a machine and partly on a remote machine, or entirely on a remote machine or a server.

In the context of the present application, the computer-readable storage medium may be a tangible medium that may include or store a computer program for use by or in connection with an instruction execution system, apparatus, or device. The computer-readable storage medium may include, but is not limited to, an electronic, magnetic, optical, electromagnetic, infrared, or semiconductor system, apparatus, or device or any appropriate combination thereof. Alternatively, the computer-readable storage medium may be a machine-readable signal medium. Examples of a machine-readable storage medium include an electrical connection based on one or more wires, a portable computer disk, a hard disk, a RAM, a ROM, an erasable programmable read-only memory (EPROM), a flash memory, an optical fiber, a portable compact disc read-only memory (CD-ROM), an optical storage device, a magnetic storage device, or any appropriate combination thereof.

In order that interaction with a user is provided, the systems and techniques described herein may be implemented on the memory processing device 10 or the data collection device 20. The device may have a display apparatus (for example, a cathode-ray tube (CRT) or a liquid-crystal display (LCD) monitor) for displaying information to the user; and a keyboard and a pointing apparatus (for example, a mouse or a trackball) through which the user can provide input for the device. Other types of apparatuses may also be used for providing interaction with a user. For example, feedback provided for the user may be sensory feedback in any form (for example, visual feedback, auditory feedback, or tactile feedback); and input from the user may be received in any form (including acoustic input, voice input, or tactile input).

The systems and techniques described herein may be implemented in a computing system including a back-end component (for example, a data server), a computing system including a middleware component (for example, an application server), a computing system including a front-end component (for example, a client computer having a graphical user interface or a web browser through which a user can interact with embodiments of the systems and techniques described herein), or a computing system including any combination of such back-end, middleware, or front-end components. Components of a system may be interconnected by any form or medium of digital data communication (for example, a communication network). Examples of the communication network include a local area network (LAN), a wide area network (WAN), a blockchain network, and the Internet.

The computing system may include clients and servers. A client and a server are generally remote from each other and typically interact through a communication network. The relationship between the client and the server arises by virtue of computer programs running on respective computers and having a client-server relationship to each other. The server may be a cloud server, also referred to as a cloud computing server or a cloud host. As a host product in a cloud computing service system, the server solves the defects of difficult management and weak service scalability in a related physical host and a related virtual private server (VPS).

An embodiment of the present application provides a computer program product including a computer program and/or computer instructions. The computer program and/or the computer instructions, when executed by a processor, cause the processor to perform the AI memory processing method according to any preceding embodiment.

It is to be understood that various forms of the preceding flows may be used with steps reordered, added, or deleted. For example, the steps described in the present application may be executed in parallel, in sequence, or in a different order as long as the desired results of the technical solutions of the present application can be achieved. The execution sequence of the steps is not limited herein.

The preceding embodiments are not intended to limit the scope of the present application. It is to be understood by those skilled in the art that various modifications, combinations, subcombinations, and substitutions may be made according to design requirements and other factors. Any modifications, equivalent substitutions, and improvements made within the spirit and principle of the present application are within the scope of the present application.

1. An artificial intelligence (AI) memory processing method, applied to a memory processing device comprising at least one processor, a memory unit communicatively connected to the at least one processor, and the method comprising:
acquiring, by the at least one processor, multimodal data from a data collection device;
converting, by the at least one processor, the multimodal data into parametric memory data and non-parametric memory data, wherein the non-parametric memory data comprises memory data stored in the memory unit, and the parametric memory data comprises memory data stored in a parameter of an AI model; and
wherein converting, by the at least one processor, the multimodal data into the non-parametric memory data comprises: sampling, by the at least one processor, the multimodal data and compressing the sampled multimodal data; and using, by the at least one processor, a multimodal encoder to convert the compressed multimodal data into a vector and storing the vector into a vector database; and
the method further comprising:
retrieving, by the at least one processor, a matching vector from the vector database according to a memory data retrieval request to obtain a memory data retrieval result.

2. (canceled)

3. The method of claim 1, further comprising:
deleting, by the at least one processor, redundant data from the vector database.

4. (canceled)

5. The method of claim 1, wherein converting the multimodal data into the parametric memory data comprises:
training, by the at least one processor, a memory model using the multimodal data to update a model parameter of the memory model.

6. The method of claim 5, further comprising:
inferring, by the at least one processor, a queried content according to the model parameter of the memory model to obtain a query result and outputting the query result.

7. The method of claim 1, wherein converting the multimodal data into the parametric memory data comprises:
converting, by the at least one processor, the multimodal data into the parametric memory data during a standby state of the memory processing device.

8. The method of claim 1, wherein,
the multimodal data comprises image data and/or video data with a first resolution; and
the method further comprises:
in response to a viewing operation of a user, performing, by the at least one processor, quality enhancement on the image data and/or the video data with the first resolution to display image data and/or video data with a second resolution to the user, wherein the second resolution is higher than the first resolution.

9. An artificial intelligence (AI) memory processing method, applied to a data collection device comprising at least one processor, a memory unit communicatively connected to the at least one processor, and the method comprising:
collecting, by the at least one processor, multimodal data;
transmitting, by the at least one processor, the multimodal data to a memory processing device, wherein the memory processing device is configured to convert the multimodal data into parametric memory data and non-parametric memory data in response to receiving of the multimodal data, wherein the non-parametric memory data comprises memory data stored in a memory unit of the memory processing device, and the parametric memory data comprises memory data stored in a parameter of an AI model; and the memory processing device is configured to convert the multimodal data into the non-parametric memory data by sampling the multimodal data and compressing the sampled multimodal data; and using a multimodal encoder to convert the compressed multimodal data into a vector and storing the vector into a vector database; and the memory processing device is further configured to retrieve a matching vector from the vector database according to a memory data retrieval request to obtain a memory data retrieval result.

10. The method of claim 9, wherein,
the multimodal data comprises image data and/or video data; and
collecting, by the at least one processor, the multimodal data comprises: collecting the image data and/or the video data according to a first resolution, wherein the first resolution is lower than a second resolution which is a resolution of image data and/or video data displayed to a user by the memory processing device.

11. The method of claim 9, further comprising:
determining, by the at least one processor, a frame rate of the multimodal data according to a trained classification model.

12. A memory processing device, comprising:
at least one processor; and
a memory unit communicatively connected to the at least one processor;
wherein the memory unit stores a computer program executable by the at least one processor to enable the at least one processor to perform:
acquiring multimodal data from a data collection device;
converting the multimodal data into parametric memory data and non-parametric memory data, wherein the non-parametric memory data comprises memory data stored in the memory unit, and the parametric memory data comprises memory data stored in a parameter of an artificial intelligence (AI) model; and
wherein the at least one processor is configured to convert the multimodal data into the non-parametric memory data by sampling the multimodal data and compressing the sampled multimodal data; and using a multimodal encoder to convert the compressed multimodal data into a vector and storing the vector into a vector database; and the at least one processor is further configured to:
retrieve a matching vector from the vector database according to a memory data retrieval request to obtain a memory data retrieval result.

13. (canceled)

14. The memory processing device of claim 12, wherein the at least one processor is further configured to delete redundant data from the vector database.

15. (canceled)

16. The memory processing device of claim 12, wherein the at least one processor is configured to convert the multimodal data into the parametric memory data by: training a memory model using the multimodal data to update a model parameter of the memory model.

17. The memory processing device of claim 16, wherein the at least one processor is further configured to infer a queried content according to the model parameter of the memory model to obtain a query result and outputting the query result.

18. A data collection device, comprising:
at least one processor; and
a memory unit communicatively connected to the at least one processor;
wherein the memory unit stores a computer program executable by the at least one processor to enable the at least one processor to perform the method of claim 9.

19. An artificial intelligence (AI) memory processing system, comprising a memory processing device and the data collection device of claim 18;
wherein the memory processing device comprises: at least one processor; and a memory unit communicatively connected to the at least one processor;
wherein the memory unit stores a computer program executable by the at least one processor to enable the at least one processor to perform: acquiring multimodal data from the data collection device; converting the multimodal data into parametric memory data and non-parametric memory data, wherein the non-parametric memory data comprises memory data stored in the memory unit, and the parametric memory data comprises memory data stored in a parameter of the AI model; wherein the at least one processor is configured to convert the multimodal data into the non-parametric memory data by sampling the multimodal data and compressing the sampled multimodal data; and using a multimodal encoder to convert the compressed multimodal data into a vector and storing the vector into a vector database; and the at least one processor is further configured to retrieve a matching vector from the vector database according to a memory data retrieval request to obtain a memory data retrieval result.

20. The system of claim 19, further comprising an inference device configured to infer a queried content according to the parametric memory data and output a query result.
